(19) United States
(12) Patent Application Publication
(10) Pub. No.: US 2014/0117028 A1
(43) Pub. Date: May 1, 2014

(54) Freight Holding Device, in Particular for Loading Aircraft, Method for Producing a Freight Holding Device and Use of a Pultruded Fibre-Reinforced Profile Element for a Freight Holding Device

(71) Applicant: Thomas Huber, Schliersee (DE)

(72) Inventor: Thomas Huber, Schliersee (DE)

(73) Assignee: Telair International GmbH, Miesbach (DE)

(21) Appl. No.: 14/124,285

(22) PCT Filed: Jun. 24, 2011
(86) PCT No.: PCT/EP2011/003114

§ 371 Date: Dec. 6, 2013

(51) Int. Cl. B65D 90/02; B29C 70/30; B65D 19/38

(52) U.S. Cl. CPC B65D 90/02; B65D 19/38; B29C 70/30
USPC 220/600; 248/346.02; 156/166

(57) ABSTRACT

A cargo holding device, such as a cargo container or pallet, in particular for loading aircraft, comprising at least one bottom element and at least one pultruded profile element of fibre-reinforced plastic.

The present invention concerns a cargo holding device such as a container, pallet or similar, in particular for loading aircraft, a method for production of a cargo holding device and a use of a pultruded profile element of fibre-reinforced plastic.

Cargo containers and freight pallets—i.e. cargo holding devices—are essential for effective transport of loads in aircraft as they allow rapid loading and unloading of the aircraft. The great majority of commercial aircraft can receive a multiplicity of cargo containers or freight pallets. Most containers or pallets are standardised so they can be used irrespective of the aircraft used for their transport. Until ten years ago, cargo containers were made exclusively of aluminium, wherein the own weight of the container was around 100 kg. Some containers used at present partly comprise lighter materials so that now, cargo containers with a weight of around 60 kg are used. It is evident that reducing the own weight of the containers or pallets used brings substantial financial and ecological benefits. Cargo containers are known for example from DE 69 702 821 T2, U.S. Pat. No. 5,941,405, DE 20 64 241 and DE 102 008 005 010 A1. The use of textiles or fabrics (see U.S. Pat. No. 4,538,663) or non-metallic materials (see JP 07257683 A, DE 69616182 T2 and DE 3409683 A1) in this context has also been considered. DE 696 16 182 T2 proposes for example a cargo container which has a frame of an aluminium alloy in which side walls and a roof of fibre-reinforced plastic are inserted. The side walls and roof are made as fabric strips of fibre-reinforced plastic. As a possible alternative to the aluminium alloy, said specification also mentions a frame of carbon-fibre-reinforced plastic material. However the technical design of such a cargo container is not described in DE 696 16 182 T2. The frame is possibly made starting from said knitted or woven fabric, by lamination or in the wrapping process.

Starting from said prior art, the object of the present invention is to provide an improved cargo holding device. In particular the own weight, production costs and production complexity of the cargo holding device should be reduced and the functionality (e.g. ease of handling, security) and stability increased.

This object is achieved by a cargo holding device according to claim 1. In particular, the object is achieved by a cargo holding device such as a container, pallet or similar, in particular for loading aircraft, wherein the cargo holding device comprises at least one bottom element and at least one pultruded profile element of fibre-reinforced plastic.

An essential concept of the present invention is to use a profile element of fibre-reinforced plastic, which is produced in the pultrusion process (extrusion-drawing process), to stabilise the cargo holding device. Because of the pultrusion process, the profile element of fibre-reinforced plastic is given a resistance, in particular against a bending load, which cannot be achieved by conventional methods for processing fibre-reinforced plastic (for the same material usage). As a whole therefore a stable construction of a cargo holding device is possible with lower material usage. This means that the weight of a cargo holding device can be further reduced substantially. Furthermore an efficient production is ensured.

Preferably at least one profile element is formed as a hollow profile, at least in portions. This allows a further weight reduction for the same or increased stability.

At least one profile element can form at least one part of a frame of the cargo holding device, in particular of the bottom element. Forces which act on the frame in such a cargo holding device can be distributed to the frame particularly favourably thanks to the pultruded design of the profile element.

At least one profile element can comprise at least one fixing device, such as for example a push-fit device, in particular a preferably round groove or a rail, for fixing a wall element, in particular a bottom element and/or a lashing device. In particular a groove or rail can be produced in the pultrusion process at little cost. This offers a weight-saving possibility for connecting different wall elements to the profile element in a simple manner. In particular if the profile element is formed as part of a frame, the cargo holding device can be assembled, dismantled and repaired in a simple manner.

In concrete embodiments, the profile element can be connected with a further profile element and/or a corner element via a push-fit connection. In particular, the push-fit connection between two profile elements can be implemented via a corner element. The push-fit connection between two profile elements can however also be made directly such that the profile elements are in contact. Two or more profile elements can also be assembled into an extended profile element via one or more (straight) intermediate piece(s). Thus in a simple manner, various profile elements can be produced or the size of the cargo holding device can easily be adapted.

In a preferred embodiment, at least one corner element is provided for connection, in particular push-fit connection, of two profile elements. The at least one corner element can have at least one pin (extension) corresponding to a recess of the profile element. In the embodiment of the profile element as a hollow profile, the pin (extension) preferably corresponds in cross-section to the cross-section of a hollow chamber of the hollow profile. This again facilitates production of the cargo holding device.

Preferably at least one (in some cases, tarpaulin-like) wall, in particular a side wall or top, is produced at least in portions from a fibre-reinforced plastic. In conjunction with the pultruded profile elements, as a whole an extremely lightweight cargo holding device can be achieved with high stability.

At least one wall, in particular a bottom wall or a cargo floor, can comprise a core layer of fibre-reinforced plastic and a seating layer (support layer) of a metal, in particular an aluminium alloy, wherein the core layer and seating layer are joined together preferably by material fit. An essential concept of this embodiment is to reduce the weight, for example of the cargo floor, in that this is made in several layers, in particular in a sandwich construction, wherein materials of metal and plastic are used for the layers. The bottom wall can be constructed as explained in German patent application file ref. DE 10 2011 050 893.7 and/or produced accordingly. Materials of metal and plastic can be used for the layers. Predefined requirements, e.g. with regard to friction and wear behaviour, can be taken into account here, wherein as a whole a very stable composite material or laminate is produced.

Preferably the layers are joined together by material and/or form fit, where a material fit join leads to particularly good results.

Preferably the seating layer of metal alloy serves as an outer layer for the action of cargo drive units. Furthermore this layer absorbs spot loads and distributes them over a broad area. An aluminium alloy is particularly suitable here since in conjunction with conventional rollers of cargo drive units, this gives a good coefficient of friction. The core layer, which preferably connects directly to the seating layer, stiffens the entire construction and leads to substantial weight savings.

The seating layer can have a thickness of 0.5 mm to 2.5 mm, in particular 0.7 mm to 1.5 mm, in particular 0.9 mm to 1.5 mm. Preferably the seating layer has only a slight thickness in relation to the thickness of the entire cargo floor, e.g. less than 40%, in particular less than 30%, in particular less than 20% of the total thickness. To this extent, significantly lighter cargo floors can be produced.

The seating layer can have a strength of more than 400 N/mm², in particular more than 500 N/mm². To this extent the seating layer can protect the core layer from high spot loads. The cargo floor according to the invention wears only slowly under the usual rough handling, and is very robust.

It is possible to design the cargo floor in a laminated structure with only two layers. Preferably however a further layer, namely a wearing layer or top layer, can be provided which is arranged on the side of the seating layer facing away from the core layer.

The wearing layer can be made of metal alloy, in particular an aluminium alloy, and/or a glass fibre-reinforced plastic and/or a material from the group of aromatic polyamides (e.g. aramide). The wearing layer can protect the core layer from wear and stiffen the sandwich construction as a whole.

Said aluminium alloys for the seating layer and/or the wearing layer can be aluminium wrought alloys. The main alloy element used can be zinc, wherein zinc accounts for a proportion of 0.7 to 13%, in particular 0.8 to 12%. Such aluminium alloys are very hard. For example 7075 T6 or 7075 T7 can be used as a material.

Preferably the wearing layer is also connected to the core layer by form and/or material fit.

Said aluminium alloys can be aluminium alloys with a solution-hardened and/or thermally hardened and/or overhardened heat treatment, to ensure an adequate strength.

The core layer can have a thickness of at least 1 mm, in particular at least 1.5 mm, in particular at least 2 mm.

Preferably the core layer comprises a solid core. According to the application, a solid core is a core which is substantially solid. This means that the core layer comprises at least 50%, in particular at least 70%, in particular at least 90% carbon-fibre-reinforced and/or glass-fibre-reinforced plastic. There are no large cohesive cavities, in particular honeycomb structures or similar.

The wearing layer can have a thickness of 0.1 mm to 1 mm, in particular 0.2 mm to 0.6 mm, in particular 0.25 mm to 0.5 mm.

Preferably at least one wall has, at least in portions, an in particular rounded bead on its edge for fixing the wall to at least one profile element. As a result, a connection to the profile element or one of the profile elements can be achieved particularly easily, in that for example the bead is inserted in a groove of the profile element.

At least one wall, in particular the bottom wall, can be bent inwards on at least one edge region. In an embodiment of the cargo holding device as a pallet, “inwards” can mean that the bend is oriented in the direction of a cargo holding surface. For a container, “inwards” can mean that the bend is oriented in the direction of a middle of the cargo holding space. In any case, as a result (in particular in combination with a round bead on the edge of a wall) a stable and in particular form-fit structure of the wall, in particular the bottom, can be achieved. The material usage is here particularly low.

At least one wall can have at least two layers of fibre-reinforced plastic, wherein a lay angle of a first layer is offset to a lay angle of a second layer by at least 30° and/or maximum 90°, in particular by 45° or 90°.

At least one wall can comprise at least one first layer with (exclusively) 0°/90° layers and at least one second layer arranged on the first layer with (exclusively) −45°/+45° layers. Reference is made here to a predefined longitudinal edge of the cargo holding device. Because of the two layers, it is possible to achieve easily both stabilisation in a corner region (by the −45°/+45° layers) and a stable fixing to the profile elements running for example along the edge (by the 0°/90° layers).

At least one wall can be made at least in portions from glass-fibre-reinforced plastic and/or carbon-fibre-reinforced plastic and/or aramide and/or Kevlar.

At least one edge bead can be formed by a rod integrated into the edge, in particular a rod made of fibre-reinforced plastic, such as glass-fibre-reinforced plastic or carbon-fibre-reinforced plastic. Thus a connection to a fixing device of a profile element can be achieved in a simple manner.

Preferably at least one wall is attached to a/the frame of the cargo holding device via at least one corner plate, wherein the corner plate has preferably at least one bore, in particular a bore at least partly lined together with the wall. Further preferably, at least one in particular tarpaulin-like wall is attached to a frame of the cargo holding device via at least one plate, wherein the plate preferably has at least one bore, wherein further preferably at least one layer of the in particular tarpaulin-like wall is pressed into the bore. Thus with a suitable fixing means with preferably cylindrical cross-section, for example a bolt, a simple and secure fixing can be ensured of the in particular tarpaulin-like wall. For this it is furthermore advantageous if the fixing means has a flange portion. The in particular tarpaulin-like wall can be clamped between this flange portion and the profile element, further improving the stability.

The plate can be arranged at least in portions inside the wall and preferably be tapered in the direction of the wall centre. This gives a comparatively homogeneous transition region from the plate to the in particular tarpaulin-like wall (in the region in which this is not connected to the plate). This further improves the stability of the fixing. The weight is reduced.

The object cited above is also achieved independently by a method for production of a cargo holding device, in particular of the type described above, comprising at least one profile element, wherein the profile element is made at least in portions by pultrusion of fibre-reinforced plastic. With regard to the advantages of the method, reference is made to the cargo holding device described above. A central advantage of this method is the possibility of producing cargo holding devices with substantially reduced own weight.

At least one wall of the cargo holding device can be made from an in particular tarpaulin-like, fibre-reinforced plastic, wherein the wall can be pressed in portions into a bore of the fixing plate, preferably using a tool with a conical portion. Thus the wall of fibre-reinforced plastic can be fixed to the profile element particularly securely.

Preferably the production method comprises production of a groove on the at least one profile element, preferably by pultrusion, and connection of the at least one wall to the at least one profile element by the introduction of a bead-like portion of the wall into the groove.

In a preferred embodiment, the method comprises a push-fit connection of a plurality of profile elements to create a frame, in particular using corner elements.

Preferably the frame is pretensioned by attachment of a/the wall to the frame.

The object cited above is furthermore achieved independently by the use of a pultruded profile element of fibre-reinforced plastic for the production of a cargo holding device, in particular of the type described above.

The present cargo holding device requires no metal components at all. In a concrete embodiment, the cargo holding device can comprise an electromagnetic transmitter and/or receiver, in particular an RFID chip. Thanks to the absence of metal components, or at least a reduction in the proportion of metal components, this electromagnetic receiver and/or transmitter device can communicate particularly easily with a corresponding external transmitter or receiver. Interference by metal components is avoided or at least reduced.

As a whole, due to the special construction of the cargo holding device, the weight is reduced further significantly in comparison with known cargo holding devices. A weight reduction of 35% or more appears possible, which for example in the case of a Boeing 747 could be around 640 kg per total load weight in comparison with loading with known containers. If we assume that a Boeing 747 with maximum load consists of around one-third aircraft, one-third passengers or freight, and around one-third fuel, and in this form has a take-off weight of around 408 tonnes, the result is that around 130 tonnes of fuel are required to transport 272 tonnes of aircraft and load. With the cargo holding device according to the invention, in such a case around 320 kg fuel can be saved on each flight. As a result, the CO₂ emissions can be further reduced substantially.

Further advantageous embodiments arise from the sub claims.

The invention is now described below with reference to several exemplary embodiments which are explained in more detail with reference to the drawings which follow.

The drawings show:

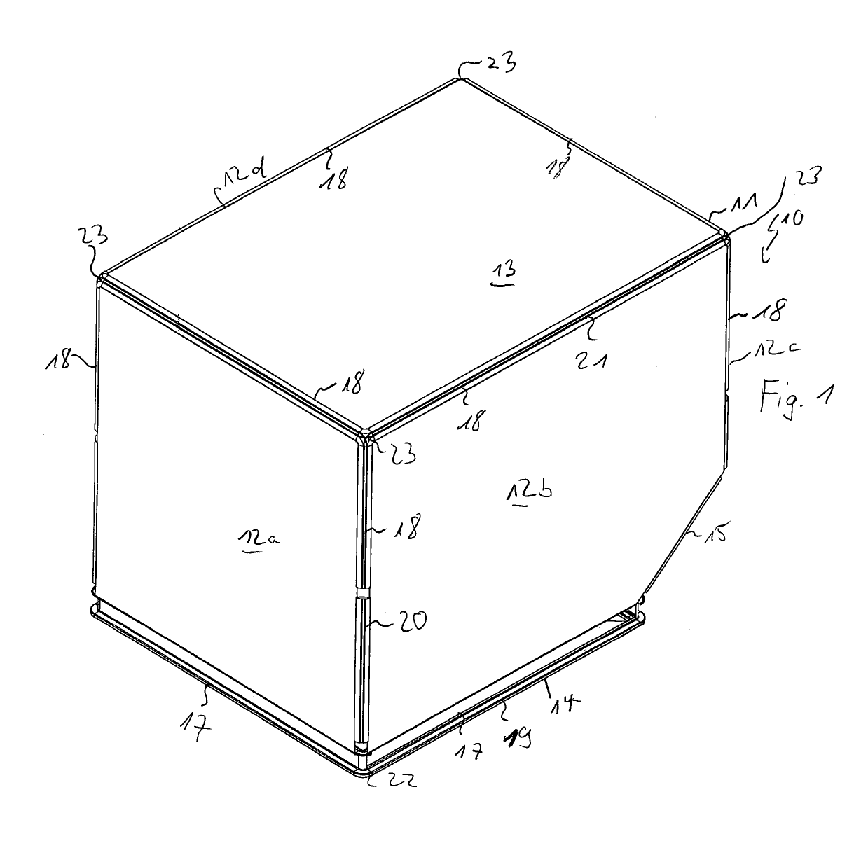

FIG. 1 a diagrammatic view of a cargo container in an oblique view;

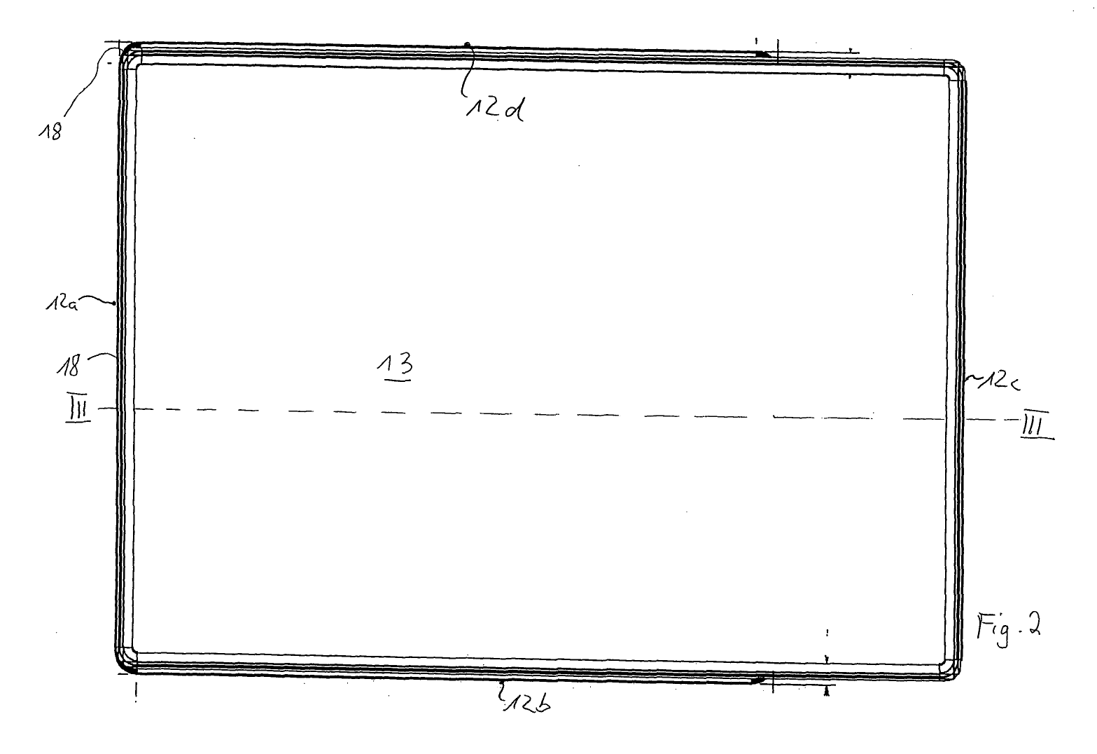

FIG. 2 the cargo container from FIG. 1 in a top view;

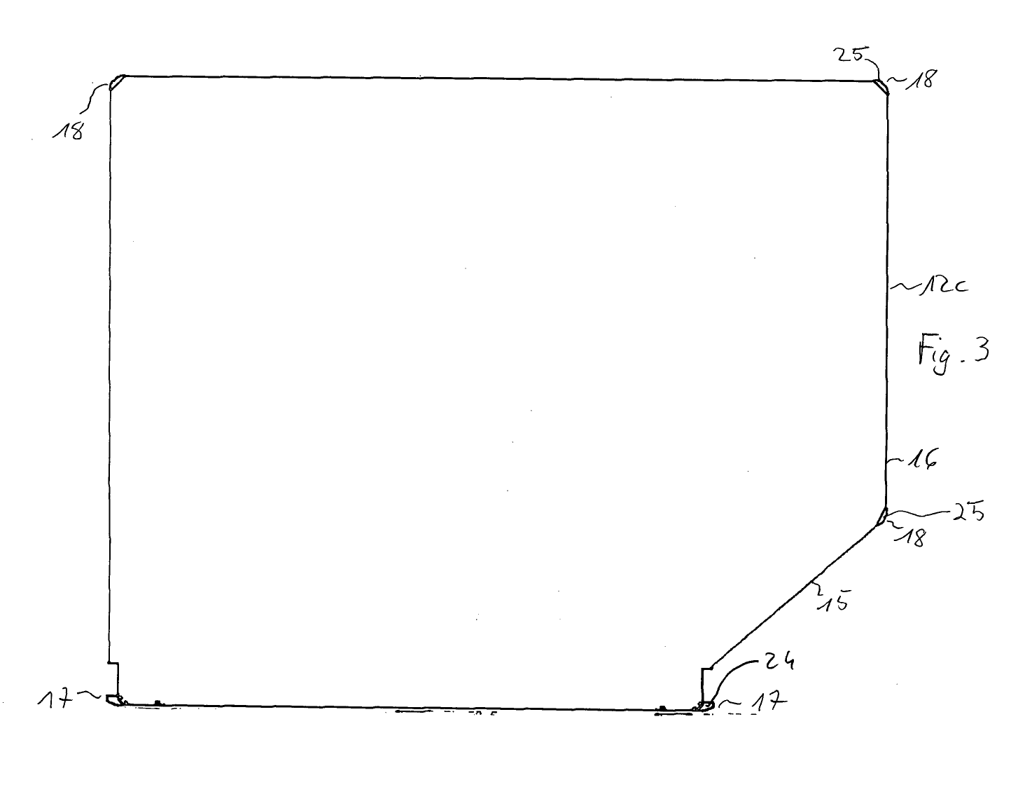

FIG. 3 the cargo container in a section view along line III-III of FIG. 2;

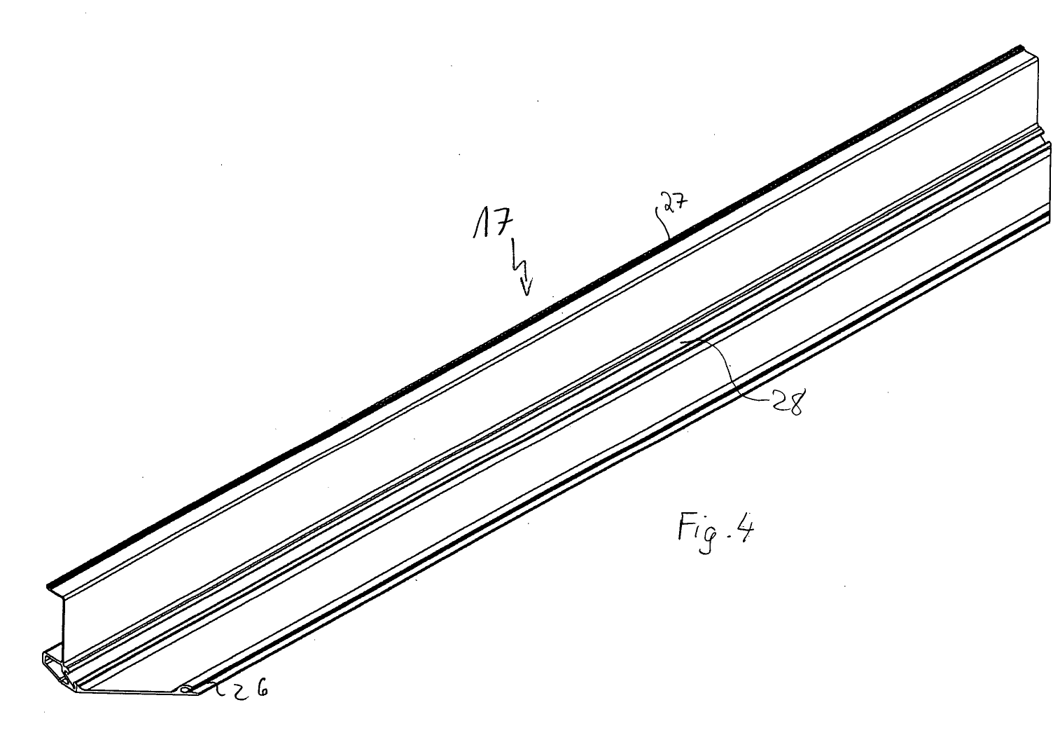

FIG. 4 a pultruded profile element in an oblique view;

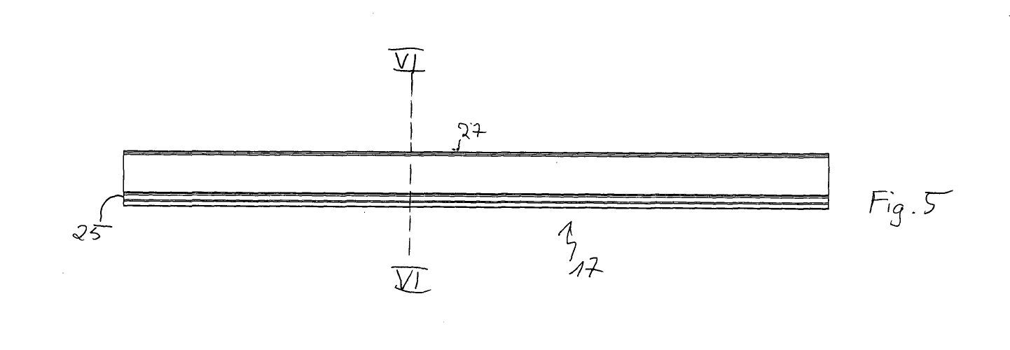

FIG. 5 the pultruded profile element according to FIG. 4 in a side view;

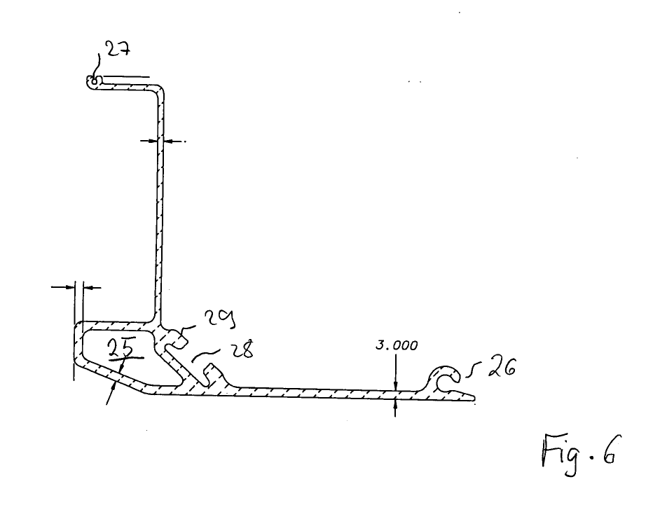

FIG. 6 a section along line VI-VI of FIG. 5;

FIG. 7 a corner element in a first oblique view;

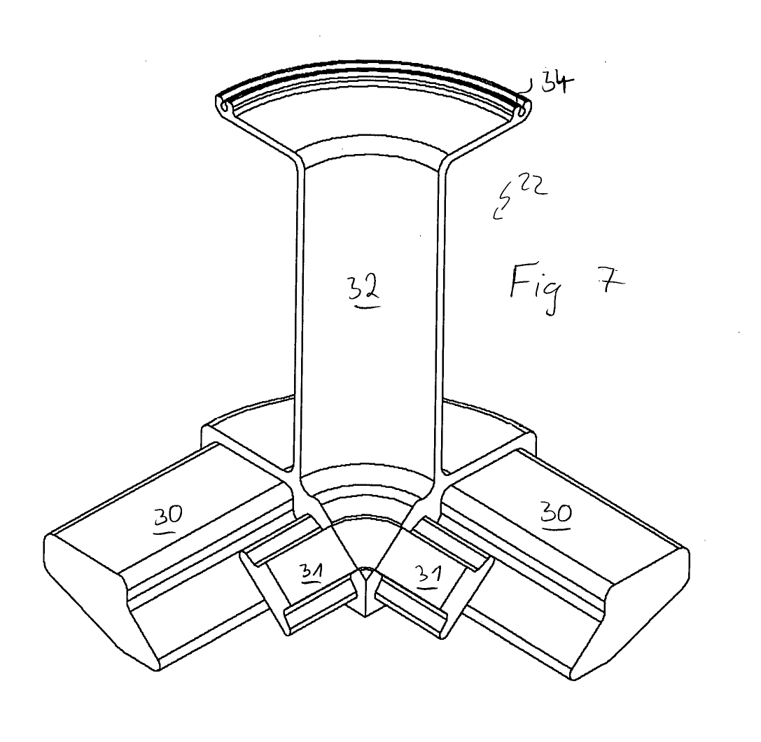

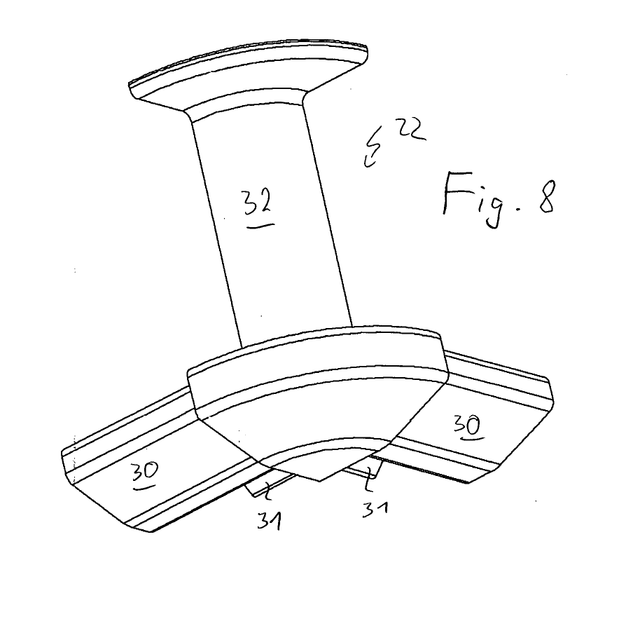

FIG. 8 the corner element from FIG. 7 in a second oblique view;

FIG. 9 a second embodiment of a pultruded profile element in a diagrammatic section view;

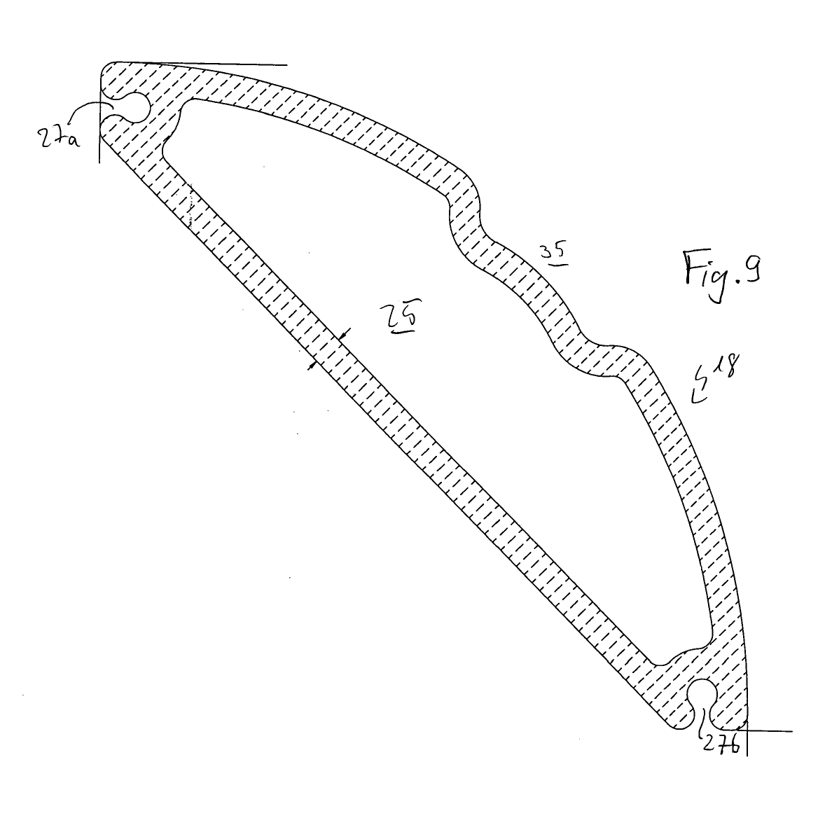

FIG. 10 a second embodiment of a corner element in a diagrammatic oblique view;

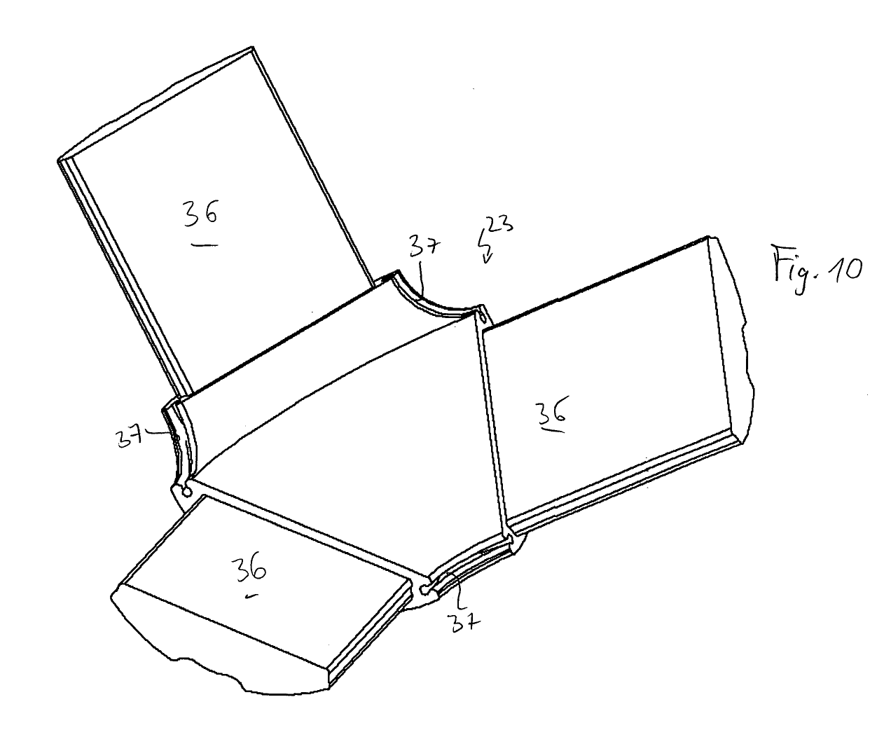

FIG. 11 the corner element according to FIG. 10 in a side view;

FIG. 12 an extract of the pultruded profile element according to the first embodiment and an extract of a bottom element, in a diagrammatic section view;

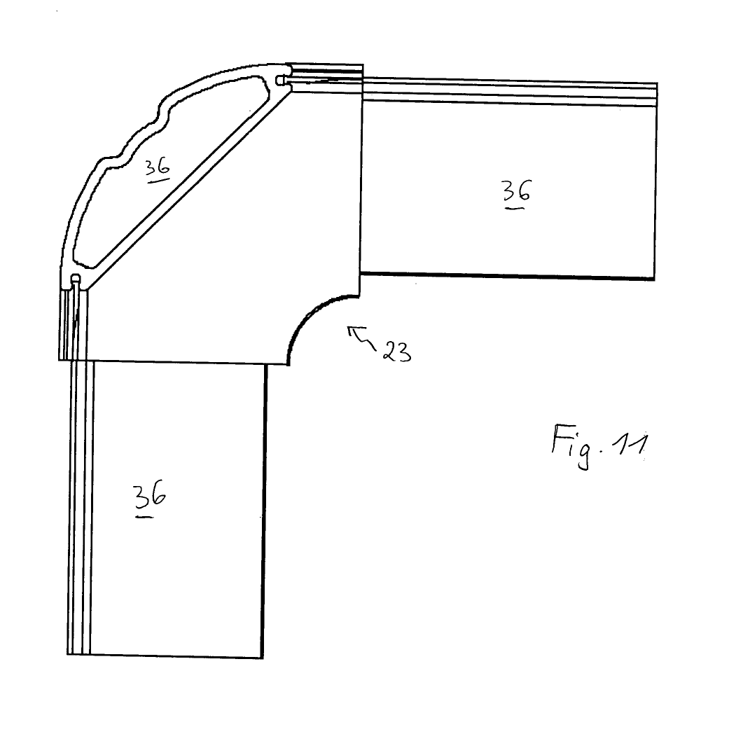

FIG. 13 parts of a wall and a mould for production of an edge bead in a diagrammatic section view;

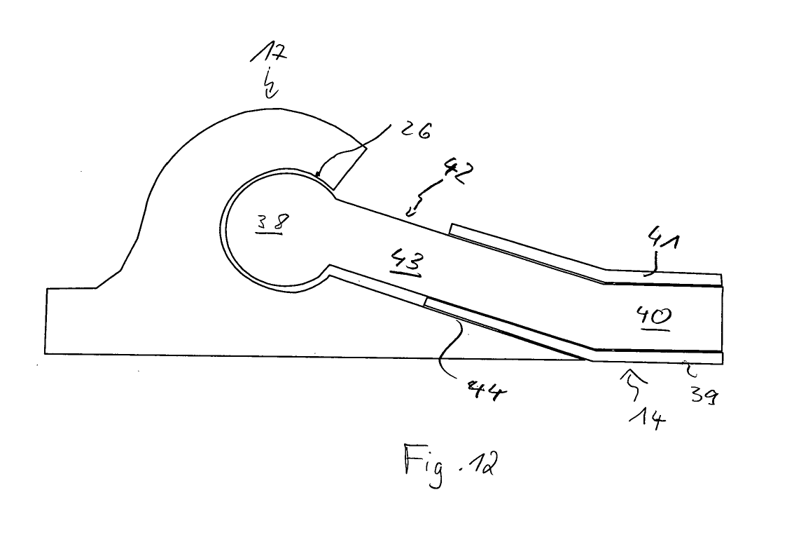

FIG. 14 an extract of an edge of a wall of the cargo holding device in a diagrammatic section view;

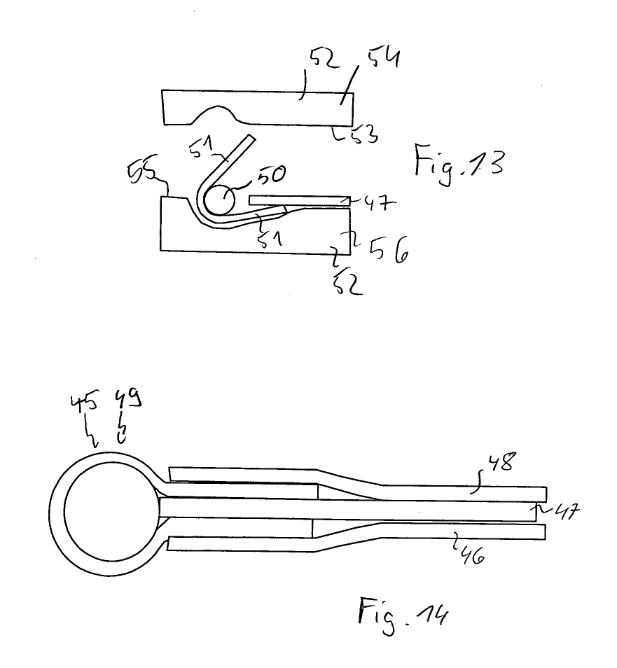

FIG. 15 a fixing of a wall of the cargo holding device to a corner element in a top view;

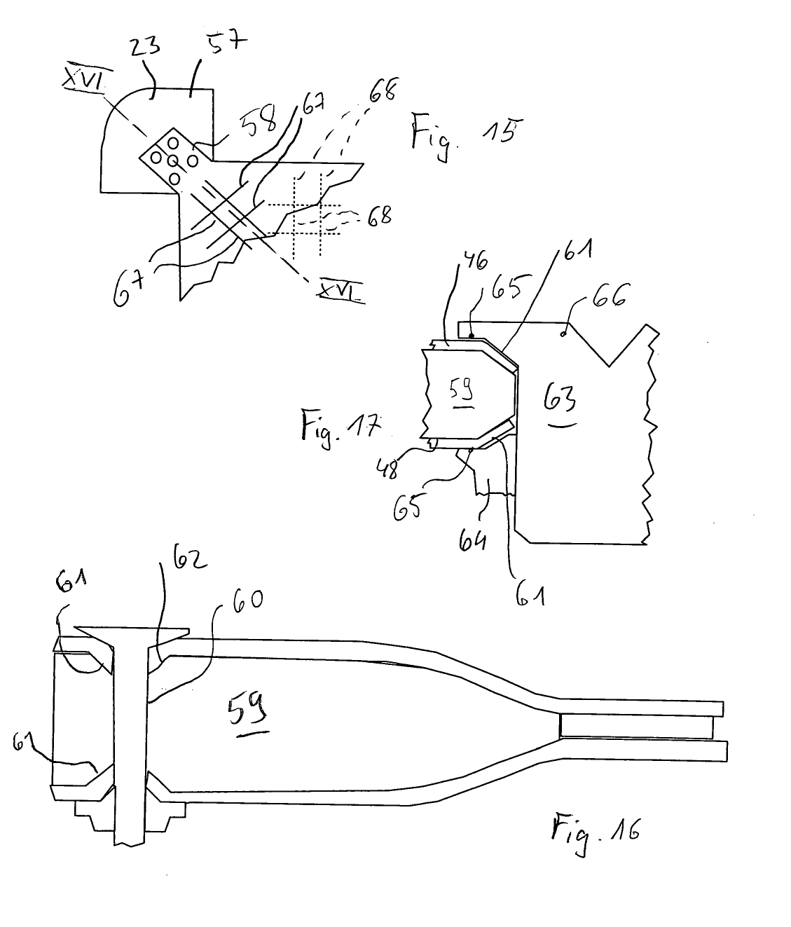

FIG. 16 a partial section along line XVI-XVI of FIG. 15;

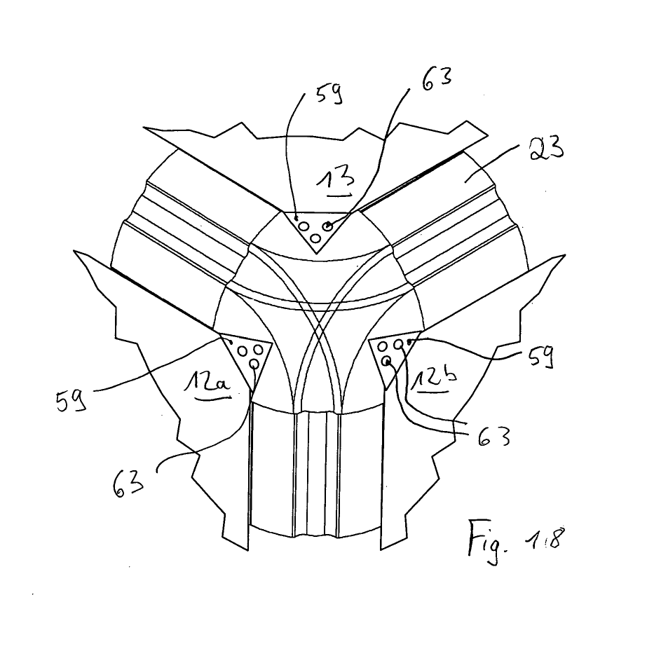

FIG. 17 an alternative possible configuration of a region of the fixing of the wall to the corner element in a diagrammatic section; and

FIG. 18 a side corner element with extracts of two side walls and a top.

In the description which follows, the same reference numerals are used for parts which are the same and parts which have the same effect.

FIG. 1 shows a cargo container 10 in an oblique view. FIG. 2 shows the cargo container in a top view. The cargo container 10 comprises a frame 11 and (attached to the frame) side walls 12a to 12d, a top 13 and a bottom 14. The side wall 12c runs obliquely outward at the bottom 14 (at a 45° angle). As well as this oblique portion 15, the side wall 12c has a vertical segment 16 which runs to the top 13. The other side walls 12a, 12b and 12d run vertically throughout in relation to the bottom 14 or the top 13.

The frame 11 comprises first profile elements 17 and second profile elements 18, wherein the first profile elements 17 and the second profile elements 18 differ in particular in their cross-section. The first profile elements 17 are part of a bottom frame 19. The second profile elements 18 are part of a side frame 20 and a top frame 21.

Bottom corner elements 22 are integrated in the bottom frame 19. Two first profile elements 17 and a second profile element 18 can be attached to the bottom corner elements 22. The side frame 20 and the top frame 21 comprise side corner elements 23 to which the three second profile elements 18 can be attached (by push-fit).

FIG. 3 shows a section along line III-III from FIG. 2. It is clear that a second profile element 18 is also arranged between the oblique portion 15 and the vertical portion 16 of the side wall 12c. It is furthermore evident that the first profile element and the second profile element are formed as hollow profiles, wherein a cavity 24 of the first profile element 17 and a cavity 25 of the second profile element 18 are formed differently.

FIG. 4 shows a profile element in an oblique view. FIG. 5 shows the profile element in a view from the side. FIG. 6 shows a section along line VI-VI from FIG. 5. As evident from FIGS. 4 and 6, the first profile element 17 comprises a bottom receiving groove 26 to receive or fix the bottom 14, and a side wall receiving groove 27 to receive or fix one of the side walls 12a to 12d, and a seat rail construction 28 for the introduction (hooking) of lashing eyes for the load.

In concrete terms, the bottom 14 or a bottom plate can be inserted in the bottom receiving groove 26. Because the bottom receiving groove is provided, no additional connecting pieces such as rivets for example are generally required. This significantly reduces both the structural complexity and the difficulty of assembly.

Side walls 12a to 12d can also be inserted in the side wall receiving groove 27. The bottom receiving groove 26 and/or the side wall receiving groove 27 preferably has a round cross-section and is suitable for holding a round bead (see below) of the bottom 14 or one of the side walls 12a to 12d or the top 13.

The seat rail construction 28 has an oblong cross-section with inwardly curved hook 29 to retain lashing eyes.

The cavity 24 of the first profile element (see FIG. 6) has an (approximately) rectangular cross-section, wherein a wall adjacent to the bottom 14 (not shown in FIG. 6) is bent up towards the outside. In particular, the inner contour of the profile element 17, 18 can vary; an outer contour can also vary, where applicable taking into account the cargo system. The inner cross sections can in particular be adapted to different loads. The outer contour can be adapted to the interface to the cargo system, for example edge corners can be configured to receive locking bolts and guides.

The bottom corner elements 22 can be extended and/or widened (in the vertical direction) with a flange plate (not shown in figures) in particular to be able to connect the first profile elements to the bottom corner elements 22 by bolting. The bottom corner elements 22 (where applicable also the side corner elements 23) can be made of a composite material (in particular a fibre composite material) or where applicable also from an aluminium alloy (cast or forged). If the corner elements comprise a metal alloy, corrosion protection can be provided between the pultruded profile elements and the corner elements (since for example carbon-fibre-reinforced plastic is comparatively aggressive towards aluminium).

The seat rail construction 28 can comprise bores (not shown in the figures) (wherein the bores can be machined subsequently and have a diameter of 19 mm) for attaching or hooking in lashing eyes (single tie-down and double tie-down studs), for example if heavy loads are to be flown in the cargo container which must be lashed additionally inside the container 10. In the case of pallets, these bores could be located all around the inside, for example for attaching pallet nets to the pallets. Previously, normally aluminium part pieces were screwed or riveted on for this. This seat rail construction 28 is integrated in the present profile element, and also preferably made of pultruded fibre composite plastic (such as carbon-fibre-reinforced plastic or glass-fibre-reinforced plastic etc.).

FIGS. 7 and 8 show one of the bottom corner elements 22 in various oblique views. The bottom corner element 22 is formed for connection (by push-fit) with two first profile elements 17. For this, two cavity receiving pins 30 are formed, onto each of which a cavity 24 of the first profile element (not shown in FIGS. 7 and 8; see FIG. 6) can be pushed. To this extent, an outer contour of the cavity receiving pins 30 corresponds to an inner contour of the cavities 24 of the first profile elements 17. Furthermore, seat rail receiving pins 31 are provided which are configured to be inserted in the seat rail construction 28 of the first profile element 17. To this extent, an outer contour of the seat rail receiving pins 31 corresponds preferably to an inner contour of the seat rail construction 28. This not only allows the seat rail construction 28 to serve for lashing (securing) the object to be transported but also contributes to further stabilisation of the cargo container 10. As a result further material can be saved, which reduces the overall weight. According to an independent concept, a cargo holding device is proposed in which at least one connection element for connecting two profile elements has at least one seat rail receiving pin, which can be introduced into a seat rail construction of a (pultruded) profile element.

The bottom element 22 comprises a side wall web 32 which extends in the direction of the side walls 12a to 12d (not shown in FIGS. 6 and 7). A (horizontal) portion is provided with an arcuate groove 34 at a distal end 33 of the side wall web 32, in order to be able to attach the side walls 12a to 12d to the first profile element 17. In assembled state (see FIG. 1), the arcuate groove 34 transforms into the side wall receiving grooves 27 of the first profile element 17.

FIG. 9 shows a cross-section of the second profile element 18 which is preferably used on all edges of the container (except the edges towards the bottom 14). The side walls 12a to 12d and the top 13 can be connected to the second profile elements preferably by pushing (via a butt-joint). Here again, no complex connection process is required, such as for example riveting.

The second profile element according to FIG. 9 comprises a first side wall receiving groove 27a and a second side wall receiving groove 27b, in order to be able to connect two side walls 12a to 12d or one of the side walls 12a to 12d to the top 13. The side wall receiving grooves 27a and 27b also have an (approximately) round or circular cross-section and are suitable for receiving a bead of the side walls 12a to 12d or the top 13. The cavity 25 of the second profile element 18 is formed (approximately) as a circle segment and has a recess 35 in the region of a circle arc. The cross-section of the second profile element also depends in particular on the loads to be held, which may vary. To this extent, the cross-section of the cavity 25 or the second profile element 18 may also deviate (from the shape shown in FIG. 9).

FIG. 10 shows a side corner element 23 in an oblique view. FIG. 11 shows the side corner element according to FIG. 10 in a side view. The side corner element 23 comprises the cavity receiving pins 36 which can be introduced into the corresponding cavities 25 of three second profile elements 18. Corner regions of the side walls 12a to 12d or the top 13 can be introduced where applicable into arcuate grooves 37. Another possibility for achieving a corner connection is shown below. As a whole, the side corner element 23 is formed as a three-legged angle bracket.

FIG. 12 shows an extract of a bottom 14 (bottom plate) which is introduced into a first profile element 17 (shown in extract). The bottom 14 comprises a (round) edge bead 38 which is introduced into the bottom receiving groove 26 of the first profile element 17. Thus (horizontal) loads which occur in operation can be absorbed in a simple manner.

The bottom 14 comprises a first floor layer 39, a second floor layer 14 and a third floor layer 41. The first (lowest) floor layer 39 is preferably made of an aluminium alloy (in particular of the 7075 series) and can ensure sufficient support against transport rollers (PDU rollers). Above the first floor layer 39, the second floor layer 40 can be made of fibre-reinforced plastic (such as carbon-fibre-reinforced plastic and/or glass-fibre-reinforced plastic) and/or aramide and/or Kevlar. The second floor layer 40, or also a third floor layer 41 lying above the second floor layer, can form a (fine) braided layer (iron braided layer) in order to ensure an electromagnetic screening where required. As a whole, more than three floor layers can be provided. A combination of one or more of said materials, in particular fibre materials, is conceivable. The thickness of the bottom plate can be 1.5 to 4.5 mm, in particular (around) 3.2 mm. A metal plate on the underside (corresponding to the first floor layer 39) can have a thickness of 0.5 to 1 mm, in particular (around) 0.75 mm.

A bottom edge 42 has an upward bend 43 (in the direction of an interior of the cargo container). This achieves a favourable (flush) transition to the first profile element 17. Furthermore delamination of a metal support can be avoided when the transport rollers (PDU rollers) run over a corner edge of the bottom in operation. The upward bend 43 runs parallel to an oblique surface 44 of the first profile element 17. As evident from FIG. 12, in particular the first floor layer 39 (metal layer) can also be provided in the region of this oblique surface 44. It is also conceivable to extend the metal layer (first floor layer 39) into the bottom receiving groove 26. Such measures both achieve a stable connection and (largely) prevent delamination. One or more of the floor layers can be made of a fibre-reinforced plastic which contains at least one −45°/+45° layer and one 0°/90° layer. The reference line here is an edge of the bottom 14 (i.e. in FIG. 12, a direction perpendicular to the drawing plane). The figures in degrees relate to a mean orientation of the fibres within the fibre-reinforced plastics.

The fundamental construction of the side walls 12a to 12d and the top 13 can be seen (in extracts) in FIG. 14. FIG. 13 shows a part of the production process for achieving the structure in FIG. 14.

The side walls 12a to 12d and the top 13 can be formed tarpaulin-like (as tarpaulins) and comprise an edge bead 45 (see FIG. 14). The edge bead 45 runs at least partly around the side walls 12a to 12d and the top 13 and can preferably be inserted in the bottom corner elements 22 or second profile elements 18.

The side walls 12a to 12d (formed as tarpaulins) and the top 13 can be made of a carbon-fibre-reinforced plastic, a glass-fibre-reinforced plastic, aramide and/or Kevlar. Other fibre composite materials are conceivable. FIG. 14 (apart from a region adjacent to the edge bead 45) shows three layers (further layers can also be provided), namely a first side wall layer 46, a second side wall layer 47, and a third side wall layer 48. Preferably the second (middle) side wall layer 47 is formed as a 0°/90° layer (in relation to a side wall edge 49 which in FIG. 14 runs perpendicular to the drawing plane). (It should be pointed out here that where the term “side wall” or “side wall edge” or similar is used below, this can always also mean the top 13 or its associated elements, unless explicitly indicated otherwise). The first side wall layer 46 and the third side wall layer 48 are preferably formed as −45°/+45° layers. FIG. 15 indicates in solid lines 67 as an example the orientation of the −45°/+45° layers. The dotted lines 68 indicate the 0°/90° layers.

The middle layer 47 is thus formed to transmit in particular (pure) tensile forces between the profile elements 17, 18. The first and third side wall layers 46, 48 are preferably formed to support the corner points of the side walls 12a to 12d (or the top 13) or to transmit tensile forces from corner to corner.

The side wall layers 46 to 48 can be 0.1 to 0.4 mm thick, in particular (around) 0.25 mm. The sidewalls 12a to 12d or the top 13 can have a total thickness of around 0.5 to 1 mm, preferably 0.75 mm. Greater thicknesses are also conceivable (in particular for correspondingly high weights).

Preferably at least one of the three side wall layers 46 to 48 is made of aramide (Kevlar), in particular to achieve a high cutting resistance of the side wall. This further improves the security of the cargo holding device. For example, no unauthorised person can (with simple means) make a slit in the side walls 12a to 12d and introduce a dangerous object (for example a bomb). The aramide (Kevlar) also ensures that the cargo holding device is even more stable against damage (for example in the event of a collision with a forklift truck or similar).

In principle the side walls 12a to 12d and the top 13 are configured such that (in particular via the edge bead 45) tensile forces at the side wall edges 49 can be absorbed by the first and second profile elements (which means that the pultruded profile elements cannot become separated from each other, or only to a limited extent, and the structure of the frame of the cargo container 10 is retained). In particular the combination of the special layer arrangement (0°/90° layers and −45°/+45° layers) and the pultruded design of the profile elements allows a particularly lightweight but nonetheless stable construction.

Formation of the side walls 12a to 12d and the top 13 as a tarpaulin has the advantage that damage such as small holes can be repaired comparatively easily with a repair piece, which can for example be glued on.

FIG. 13 shows diagrammatically a first part of a production process for the edge bead 45. In a first step, a rod 50 is produced. The rod 50 can preferably be made of fibre-reinforced plastic (carbon-fibre-reinforced or glass-fibre-reinforced) and furthermore preferably be produced in a pultrusion process. The rod can have a diameter for example of 1.5 to 2.5 mm. The rod 50 is connected (preferably integrally) with tabs 51 (as portions, in particular flat, running along the rod). Preferably the rod 50 and the tabs 51 can be pultruded in a common pultrusion process. This considerably simplifies the production process. According to a concept claimed independently, a rod can thus be pultruded to form an edge bead of the side wall (or top or bottom) with two tabs running along the rod. The tabs 51 can stand at an angle of (around) 45 to 60° to each other.

The rod 50 with the tabs 51 can be laid in a mould 52. Further side wall layers (FIG. 13 shows the side wall layer 47) can already be laid in the mould 52.

Preferably (not shown in FIG. 13) at least one further side wall layer in each case is arranged respectively on an inner face 53 of the first moulding tool 54 and on an inner face 55 of a second moulding tool 56. A preferred process sequence can then be as follows:
Introduction of the first side wall layer 46 (not shown in FIG. 13) into the first moulding tool 45;
Laying of the rod 50 with the tabs 51 between the first moulding tool 54 and the second moulding tool 56;
Introduction of the second side wall layer 47 on the (lower) tab 51 or between the tabs 51;
Introduction of the third side wall layer 48 (not shown in FIG. 13) between the second moulding tool 56 and the rod 50 with tabs 51;
Advance of the mould 52 or bringing together the first moulding tool 54 and the second moulding tool 56;
Optional heat application to join the side wall layers 46 to 48.

One or more of these steps can also be omitted. On advance of the mould 52, the tabs 51 are compressed and the rod 50 (load-bearing) is connected to the side wall 12a to 12d or the top 13.

For example, a further corner plate can be inserted in a corner region (see below) before the third side wall layer 48 is introduced.

FIGS. 15 to 18 show the attachment of the side walls 12a to 12d or the top 13 to a corner region 57 (see FIG. 15) of the frame. A corner plate 59 (see FIG. 16) is inserted in a side wall corner region 58. The corner plates 59 can for example have a triangular or rectangular contour and/or a thickness of (around) 1 to 4 mm, preferably 2 to 3 mm. The corner plates 59 can where applicable also be attached to the bottom corner elements 22 or side corner elements 23 by bolting and/or riveting.

The corner plates 59 inserted in the side walls 12a to 12d or the top 13 can where applicable dissipate forces via −45°/+45° layers, such that the frame 11 of the cargo container 10 cannot shift obliquely (as is the case for example with known supporting structures for bridges or decks). Thanks to the different layer directions (−45°/+45° and 0°/90°), with low material usage and low weight, a high-strength construction can be achieved which directly transfers loads from (pure) tensile forces into the frame 11 via the side walls or top (and vice versa). Also it is easy to exchange a damaged side wall or top, since no fixed connections such as rivets are required and the side walls or top can easily be drawn out of the profile elements in large parts (and where applicable may need to be unbolted at the corners). The push-fit construction of the frame 11 according to the invention further facilitates such an exchange.

The corner plates 59 can either be a (preproduced) plastic part (where applicable comprising a fibre component) or a metal part (for example of an aluminium alloy), in particular a punched metal part. Here too (in the connection of a metal or in particular aluminium part) corrosion protection must be ensured, in particular when carbon-fibre-reinforced plastic is used. Bores 60 (see FIG. 16) can be preproduced in the corner plates 59. These bores 60 can have a (comparatively high) edge break 61 (on one or both opposing outer faces of the corner plate 59). Preferably the corner plate tapers in the direction of a middle of the respective side wall 12a to 12d or top 13, in particular to provide a stable (flush) transition from the plate, approximately 2-3 mm thick, to the (around) 0.75 mm thick tarpaulin.

A mould for producing the connection of the respective side wall 12a to 12d or top 13 to the corner plate 59 can have a pin with a conical portion to press material of one of the side wall layers 46 to 48, in particular of the first side wall layer 46 and/or of the third side wall layer 48, into the bores 60 or their edge breaks 61 (see FIG. 16). For this it is necessary to position the corner plate 49 as precisely as possible in the production mould. The first side wall layer 46 and the third side wall layer 48 can be pressed (obliquely downward) on closure of the mould into a depression 62 delimited by the edge break 61. The fibres should not be destroyed here, but should be shaped around the bore 60.

The extract according to FIG. 17 shows further details of a bolt joint with a bolt 63 and a nut 64. Both the bolt 63 and the nut 64 have a (comparatively large) flange portion 65 (the flange portions 65 need not be provided simultaneously)

Overall, the bolt 63 has an enlarged head 66 which can be adapted to the first edge break 61. The first side wall layer 46 is bent inward by the production process described above. The third side wall layer 48 is bent inward accordingly in the region of the associated edge break 61. As a whole, the present construction achieves an improved and clearly defined force flow in the corner region 57.

FIG. 18 shows a diagrammatic oblique view of a side corner element 23 with an extract of a side wall 12a, a side wall 12b and the top 13. The side walls 12a, 12b and the top 13 are connected to the side corner element 23 via corresponding corner plates 59. The corner plates 59 have a triangular contour and are connected via several (three) bolts 63 firstly to the side walls 12a, 12b and the top 13, and secondly to the side corner element 23. According to the diagrammatic depiction in FIG. 17, the corner plates 59 are arranged above the side walls 12a, 12b and the top 13. In a preferred embodiment however, the corner plates 59 are introduced into the side walls 12a, 12b and the top 13 (at least in regions) (see FIGS. 15 to 17).

It should be pointed out here that all parts described above are claimed as essential to the invention both viewed alone and in any combination, in particular the details depicted in the drawings. Derivations from this are well known to the person skilled in the art.

### LIST OF REFERENCE NUMERALS

10 Cargo container

11 Frame

12a to 12d Side wall

13 Top

14 Bottom

15 Oblique portion

16 Vertical portion

17 First profile element

18 Second profile element

19 Bottom frame

20 Side frame

21 Top frame

22 Bottom corner element

23 Side corner element

24 Cavity

25 Cavity

26 Bottom receiving groove

27, 27a, 27b Side wall receiving groove

28 Seat rail construction

29 Hook

30 Cavity receiving pin

31 Seat rail receiving pin

32 Side wall web

33 Distal end

34 Arcuate groove

35 Recess

36 Cavity receiving pin

37 Arcuate groove

38 Edge bead

39 First floor layer

40 Second floor layer

41 Third floor layer

42 Bottom wall

43 Upward bend

44 Sloping surface

45 Edge bead

46 First side wall layer

47 Second side wall layer

48 Third side wall layer

49 Side wall edge

50 Rod

51 Tab

52 Mould

53 Inner face

54 First moulding tool

55 Inner face

56 Second moulding tool

57 Corner region

58 Side wall corner region

59 Corner region

60 Bore

61 Edge break

62 Depression

63 Bolt

64 Nut

65 Flange portion

66 Head

67 Line

68 Lines

1. A cargo holding device, such as a cargo container or pallet, in particular for loading aircraft, comprising at least one bottom element and at least one pultruded profile element of fibre-reinforced plastic.

2. The cargo holding device according to claim 1, wherein the at least one profile element is formed at least in portions as a hollow profile.

3. The cargo holding device according to claim 1, wherein at least one profile element forms at least a part of a frame of the cargo holding device, in particular of the bottom element or a bottom.

4. The cargo holding device according to claim 1, wherein at least one profile element comprises at least one fixing device, such as for example a push-fit device, in particular a preferably round groove or a rail for fixing a wall element, in particular a bottom element and/or a lashing device.

5. The cargo holding device according to claim 1, wherein at least one profile element is connected to a further profile element and/or a corner element via a push-fit connection.

6. The cargo holding device according to claim 1, including at least one corner element for connection, in particular by push fit, of two profile elements, wherein at least one corner element has at least one extension preferably corresponding to the recess of one of the profile elements.

7. The cargo holding device according to claim 1, wherein at least one wall, in particular a side wall or top is made at least in portions from a fibre-reinforced plastic.

8. The cargo holding device according to claim 1, wherein at least one wall comprises, at least in portions, an in particular round bead on its edge for fixing the wall to at least one profile element and/or corner element.

9. The cargo holding device according to claim 1, wherein at least one wall, in particular the bottom, is bent inwards on at least one edge region.

10. The cargo holding device according to claim 1, wherein at least one wall comprises at least two layers of fibre-reinforced plastic, wherein a lay angle of a first layer is offset to a lay angle of a second layer by at least 30° and/or maximum 90°, in particular by 45° or 90°.

11. The cargo holding device according to claim 10, wherein at leat one wall comprises at least one first layer with 0°/90° layers and at least one second layer arranged on the first layer with −45°/+45° layers.

12. The cargo holding device according to claim 1, wherein at least one wall is mae at least in portions from glass-fibre-reinforced plastic and/or carbon-fibre-reinforced plastic and/or aramide and/or Kevlar.

13. The cargo holding device according to claim 1, wherein at least one edge bead is formed by a rod integrated into the edge, in particular a rod made of fibre-reinforced plastic, such as glass-fibre-reinforced plastic or carbon-fibre-reinforced plastic.

14. The cargo holding device according to claim 1, wherein at least one wall is attached to a/the frame of the cargo holding device via at least one corner plate, wherein the corner plate has preferably at least one bore, in particular a bore at least partly lined together with the wall.

15. The cargo holding device according to claim 14, wherein the corner plate is arranged at least in portions inside the wall and is preferably tapered in the direction of a wall centre.

16. A method for production of a cargo holding device according to claim 1, comprising at least one profile element, including production of the at least one profile element at least in portions by pultrusion of fibre-reinforced plastic.

17. The method according to claim 16, including production of at least one wall of the cargo holding device from a fibre-reinforced plastic, wherein the wall can be pressed in portions into a bore of a fixing plate, preferably using a tool with a conical portion.

18. The method according to claim 16 including production of a groove on the at least one profile element, preferably by pultrusion, and connection of the at least one wall to the at least one profile element by the introduction of a bead-like portion of the wall into the groove.

19. The method according to claim 16, including a push-fit connection of a plurality of profile elements to create a frame, in particular using corner elements.

20. The method according to claim 19, including a pretensioning of the frame by an attachment of a/the wall to the frame.

21. A method for the production of a frame of a cargo holding device, the method including the use of a pultruded profile element of fibre-reinforced plastic.
